(19) United States
(12) Patent Application Publication
(10) Pub. No.: US 2011/0210854 A1
(43) Pub. Date: Sep. 1, 2011

(54) Building safety detector assembly

(76) Inventor: Chris Kelly, Wayne, NJ (US)

(21) Appl. No.: 12/655,526

(22) Filed: Dec. 31, 2009

(51) Int. Cl. G08B 17/00; G08B 21/00; G08B 17/10

(52) U.S. Cl. 340/584; 340/540; 340/632

(57) ABSTRACT

A building alarm system detector arrangement, comprising a system detector base, at least one detector, and at least one interface, wherein the interface is adapted to provide a mechanical and electrical connection between the system detector base and the at least one detector a plurality of the detector and between a plurality of the at least one detector.

### RELATED APPLICATIONS

Co-pending U.S. patent application Ser. No. 12/383,304 filed on Mar. 23, 2009, is incorporated herein by reference in its entirety.

### FIELD OF THE INVENTION

The present invention relates to a device for use in an alarm system, and more specifically to a detector for use in a building environment to detect airborne compounds and or contaminates. The present invention generally relates to a device and system for interchangeably attaching detectors to a building alarm system for alerting individuals within a protected area of the presence of an emergency situation. More particularly, the present invention relates to the system for connecting a plurality of variable and interchangeable detectors to a building alarm system.

### STATEMENT OF THE PROBLEM

Fire alarm systems used in buildings and such are designed to save lives and comprise a number of components including devices such as smoke and heat sensors, and audible and visible indicators. Fire alarm systems of the prior art may utilize separate and distinct types of detectors to be incorporated into the system. These detectors may include smoke detectors, carbon monoxide detectors, heat detectors and other such detectors adapted to detect a particular contaminate in the air, or a change in the ambient conditions. The detectors are typically installed within a building and linked to a central control system by means of a physical communication path to transmit information between components including electrical and optical media. However, typically it is known to install various types of detectors individually with separate and distinct mountings. Therefore, it is difficult to change or move detectors into different locations, also, individual detector bases are needed to mount multiple detectors thereby increasing the costs of both parts and labor for a detector installation.

### SUMMARY OF THE INVENTION

Through the invention a standardized detector assembly interface for use between existing system detectors and system base units, multiple system detector assembly units may be attached to a single system detector base, and therefore a reduction in parts and labor costs, are to be made possible. The object of the present invention is that a single detector base can be used with a standardized interface for attaching a system detector assembly having a standardized mounting and electrical connection configuration. In addition in alternate embodiments more than one standardized interface may be used to mount more than one detector assembly on a single system detector base.

This object is achieved according to the invention in that the field selectable interface is of a standardized configuration and is adaptable to mount on an existing standard system detector base and receive standardized system detector assemblies. Furthermore the field selectable interface is configured to receive a plurality of system detector assemblies, which are of standardized construction and are compatible with the interface.

The standardized configuration and mount allow for mounting multiple system detector assembles utilizing a standard system detector base, which allows for greater efficiency in terms of a system installation and greater adaptability for the system uses.

The detector according to the invention is therefore A building alarm system detector arrangement, comprising a system detector base, at least one detector, and at least one interface, wherein the interface is adapted to provide a mechanical and electrical connection between the system detector base and the at least one detector a plurality of the detector and between a plurality of the at least one detector.

### DESCRIPTION OF THE DRAWINGS

The same reference number represents the same element or same type of element on all drawings.

FIG. 1 is a view of a first embodiment of a system detector assembly according to the invention seen from the side;

FIG. 2 is a plan view of a system detector assembly according to the present invention.

FIG. 3 is a side view of an alternate embodiment of a system detector assembly according to the present invention.

### DETAILED DESCRIPTION OF THE INVENTION

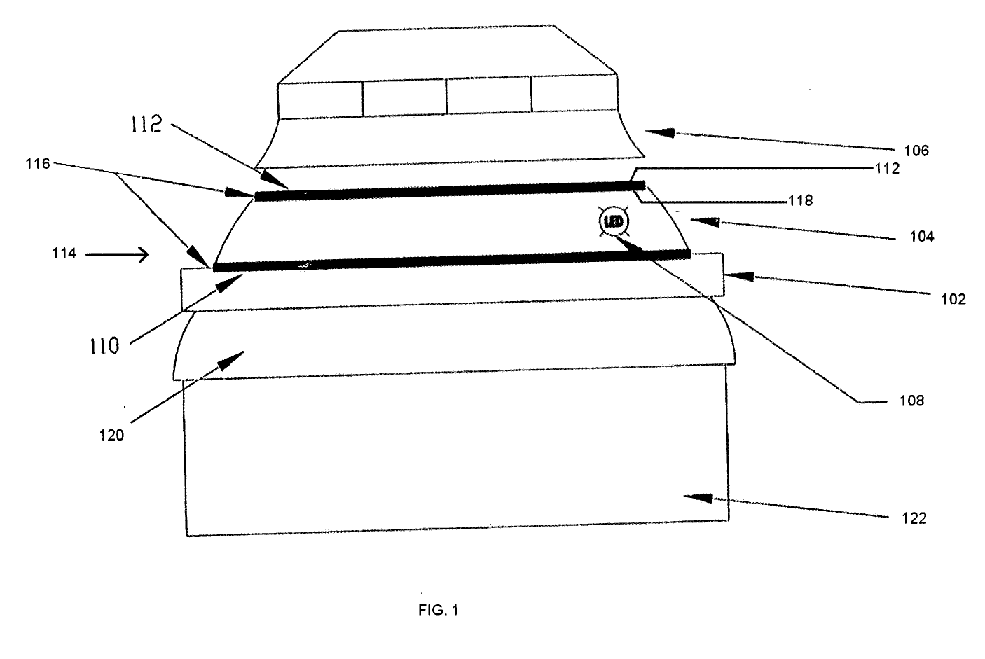

Referring initially to FIG. 1, illustrated therein is an overall diagrammatic view of a system detector assembly arrangement 100 according to the present invention. The system detector assembly arrangement 100 includes system detector base 102, a detection appliance 104 with interface, a system detector assembly 106 and field selectable interfaces 114 and 116. In a typical installation, the system detector assembly arrangement may be attached to an interior ceiling (not shown) of a building room by affixing the system detector base 102 to an interior ceiling, although other installations known in the art are contemplated within the scope of this invention. In the embodiment depicted there is shown a system detector base 102, having mounted thereon a user selectable interface 114. In the embodiment depicted the user selectable interface 104 is a gas detection appliance and also provides an intermediate connection between the system detector base 102 and a system detection assembly 106 using field selectable interfaces 114 and 116. As will be more fully depicted and described hereinafter, the user selectable interface 114 and 116 has electrical connector for providing electrical connections to the system base for both power supply and signal transmission. The interface 114 and 116 is designed to be attached to between any of a plurality of components such as detector base 102, detection appliance 104 or system detection assembly 106 in a predetermined orientation. The interface 114 and 116 may in the embodiment depicted have a base connections side 110 and a system detection assembly 106 connection side 112. The interface 114 further provides a mechanical connection for attaching the detection appliance 104 to the system detector base 102 and for providing an attaching mechanism for system detection appliance 104 to the detection assembly 106. In this way the interface can provide both an intermediate electrical and mechanical connection for attaching both the detection appliance 104 and the system detection assembly 106 to the existing system detection base 102. While one particular orientation and arrangement of detection base 102, detection appliance 104 and system detection appliance 106 are shown and described, any arrangement and orientation of detection appliances and detection assemblies known in the art are contemplated within the scope of the present invention.

In the embodiment depicted in FIG. 1, the detection appliance 104 is shown as including a gas detection appliance. Such an appliance may include, but is not limited to a carbon monoxide detector for example. Detection appliance 104 includes an LED 108 for indicating an alarm condition, such as the detection of a carbon monoxide gas. The detection appliance 104 may also include an audible warning device for sounding an audible warning in the event of an alarm condition. As is currently known in the art optical, optical-thermal and thermal fire detectors are typically used in building safety systems, along with gas detectors, which may include a combustion gas sensor. The detectors illustrated herein represent the optical, optical-thermal variants and combustion gas sensors where applicable). Additionally, there by be included a temperature sensor as known in the art. In accordance with the present invention, while technical differences may exist within the provided detector, the mechanical construction and associated mounting structures and electrical connections are standardized in order to provide a common connection means for attaching a plurality of detectors to a single detector base 102.

As stated above, in a typical installation, the system detector assembly arrangement may be attached to an interior ceiling (not shown) of a building room by affixing the system detector base 102 to an interior ceiling, although other installations known in the art are contemplated within the scope of this invention. FIG. 1 further depicts such an alternate mounting of the present invention, whereby a system detector base 108, may be connected to an optional interface 120. The optional interface 120 provides a mechanical and electrical connection between an existing detector base 108 and an industry standard junction box 122. In this way, the system and device according to the present invention may be retrofitted to an existing industry standard junction box.

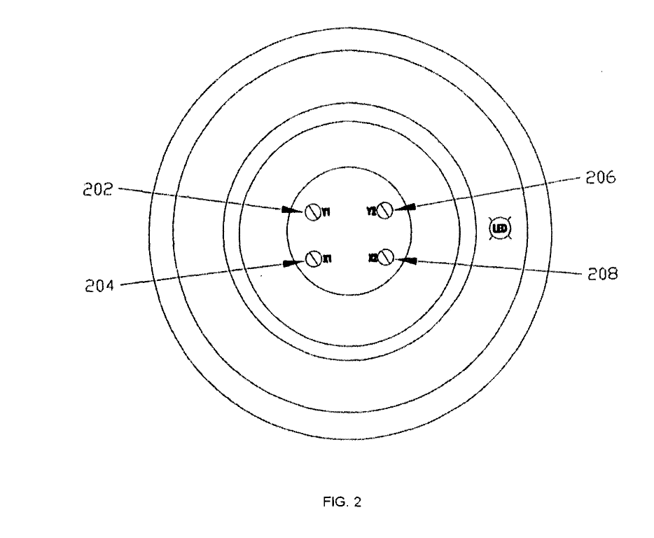

Now turning to FIG. 2 there is shown a plan view of interface 114 and 116 depicting the system detector assembly side 112. Interface 114 in this embodiment is a generally circular shape adapted to connect to a system detector base (not shown in this view) and to receive a system detector assembly 106 by attaching to the system detector assembly side. The interface 114 and 116 is adapted to receive and mechanically secure the system detector assembly by means of a mechanical connection. The connection may embody various means for holding the two components together. For example, the interface may connect to the base by way of a snap fit mechanism, resilient tabs or by a bayonet mount which are known in the art. Each type of mount is contemplated within the scope of the present invention and may be used to ensure a positive mechanical connection between the interface and the base as well as provide adequate electrical connectivity for electrical connectors 202-208.

Interface 104 further includes electrical connections for providing electrical power to the interface appliance, shown in this view as a gas detector and for transmitting electrical signals from the interface appliance and the connected detector assembly, as depicted in FIG. 1. The electrical connections on the detector assembly side 112 depicted as connectors 202-208, provide point contact points for electrical current and signals to be carried from the base to the interface module. The electrical connections on the detector base side (not shown) provide a low voltage electrical current to power the interface 104 appliance circuitry and are electrically connected to the connections located on the interface detector assembly side 112 for providing a low voltage electrical current to a detector assembly 106. Furthermore electrical connectors (206-208) provide connection for transmitting low voltage signals from the circuitry of the interface 104 and attached detector assembly 106 to a central building alarm system via circuitry located and installed in a building. While not depicted, interface 114 and 116 include connections on detection appliance 102 side 118 which are adapted to connect to a detection appliance. Similarly, each interface 114 or 116 may adapted to provide connections between a plurality of detectors and bases known in the art.

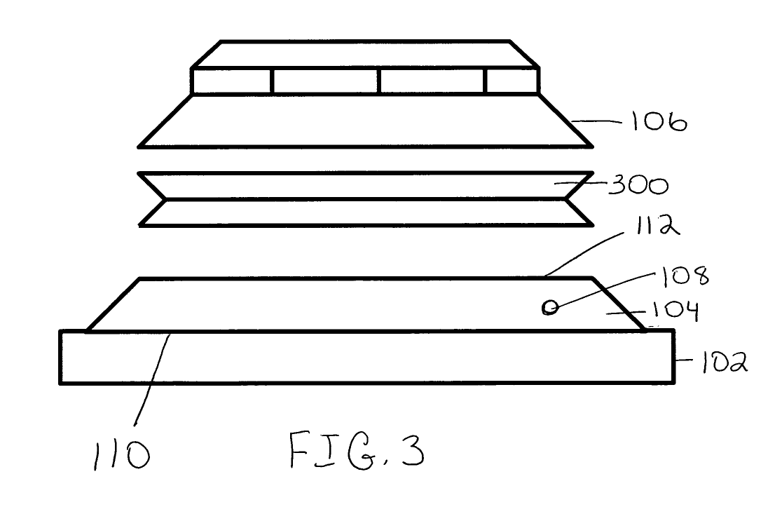

Turning to FIG. 3 there is depicted an alternate embodiment of the present invention. In the alternate embodiment, there is shown a secondary stacked component 300 which may be an additional system detector as described above or may include alternate devices. Such alternate devices may include for example, component 300 may be a 802.11 router which may be incorporated into the arrangement, whereby an 802.11 router is attached to a base plate, and the interface and detector assembly may be attached to the router, in this way a system detector device may transmit data to a central building alarm system as set forth in co-pending U.S. patent application Ser. No. 12/383,304 filed on Mar. 23, 2009, the contents of which is incorporated herein by referenced. In this way, an existing building safety system could be retrofitted to include wireless data communication to a central building alarm control unit in accordance with the co-pending application cited above. In addition, in another embodiment, several appliances or detectors may be stacked on top of a single detector base. For example a single base may include a carbon monoxide detector as component 300 along with system detector 106. Such combinations are not limited to the different units listed herein, but may include any other possible detectors known in the art. Furthermore, the combinations, need not be limited to two such components, but any number of components may be stacked.

Although specific embodiments were described herein, the scope of the invention is not limited to those specific embodiments. The scope of the invention is defined by the following claims and any equivalents thereof.

What is claimed is:

1. A building alarm system detector arrangement, comprising a system detector base, at least one detector, and at least one interface, wherein said interface is adapted to provide a mechanical and electrical connection between said system detector base and said at least one detector and a mechanical and electrical connection between a plurality of said at least one detector.

2. The building alarm system detector arrangement according to claim 1 wherein said mechanical connection comprises an annular snap fit interface.

3. The building alarm system detector arrangement according to claim 1 wherein said electrical connection provides electrical connections for both electrical power and electrical signals.

4. The building alarm system detector arrangement according to claim 2, wherein said annular snap fit interface comprises a annular ring adapted to receive a circumfential annular insert within the inner diameter of said annular ring.

5. The building alarm system detector arrangement according to claim 1, wherein one of said at least one detector is a gas detector.

6. The building alarm system detector arrangement according to claim 1, wherein one of said at least one detector is an optical detector.

7. The building alarm system detector arrangement according to claim 1, wherein one of said at least one detector is an optical-thermal detector.

8. The building alarm system detector arrangement according to claim 1, wherein one of said at least one detector is a thermal-fire detector.

9. The building alarm system detector arrangement according to claim 1, wherein one of said at least one detector is a combustion gas detector.

10. The building alarm system detector arrangement according to claim 1, wherein one of said at least one detector is gas detector.

11. The building alarm system detector arrangement according to claim 1, further comprising a wireless signal router module for receiving data from said at least one detector and transmitting said data to a central controller.

12. A building alarm system detector arrangement, comprising a system detector base, at least one detector, and at least one first interface, and a second interface wherein said first interface is adapted to provide a mechanical and electrical connection between said system detector base and said at least one detector and a mechanical and electrical connection between a plurality of said at least one detector and wherein said second interface is adapted to provide a mechanical and electrical connection between said system detector base and an industry standard junction box.

13. The building alarm system detector arrangement according to claim 12 wherein said mechanical connection comprises an annular snap fit interface.

14. The building alarm system detector arrangement according to claim 12 wherein said electrical connection provides electrical connections for both electrical power and electrical signals.

15. The building alarm system detector arrangement according to claim 13, wherein said annular snap fit interface comprises a annular ring adapted to receive a circumfential annular insert within the inner diameter of said annular ring.

16. The building alarm system detector arrangement according to claim 12, wherein one of said at least one detector is a gas detector.

17. The building alarm system detector arrangement according to claim 12, wherein one of said at least one detector is an optical detector.

18. The building alarm system detector arrangement according to claim 12, wherein one of said at least one detector is an optical-thermal detector.

19. The building alarm system detector arrangement according to claim 12, wherein one of said at least one detector is a thermal-fire detector.

20. The building alarm system detector arrangement according to claim 12, wherein one of said at least one detector is a combustion gas detector.

21. The building alarm system detector arrangement according to claim 12, wherein one of said at least one detector is gas detector.

22. The building alarm system detector arrangement according to claim 12, further comprising a wireless signal router module for receiving data from said at least one detector and transmitting said data to a central controller
